(19) United States
(12) Patent Application Publication
(10) Pub. No.: US 2026/0175392 A1
(43) Pub. Date: Jun. 25, 2026

(54) ACCESSORY AND INSERT FOR AN OSCILLATING POWER TOOL AND COMBINATION OF AN OSCILLATING POWER TOOL AND AN ACCESSORY

(71) Applicant: Robert Bosch GmbH, Stuttgart (DE)

(72) Inventors: Walter Bernardi, Highland Park, IL (US); Daniel Schadegg, Buffalo Grove, IL (US)

(21) Appl. No.: 19/407,198

(22) Filed: Dec. 3, 2025

Related U.S. Application Data
(60) Provisional application No. 63/738,095, filed on Dec. 23, 2024.

(51) Int. Cl. B25F 3/00; B25F 5/00

(52) U.S. Cl. CPC B25F 3/00; B25F 5/00

(57) ABSTRACT

An oscillating power tool accessory comprising: a working portion and a mounting portion to be clamped between a clamping flange and a spindle head of an accessory holder. The mounting portion includes a first clamping face and a second clamping face opposite from the first clamping face, a spindle opening configured to accommodate a spindle of the tool. The first clamping face, the spindle opening and the second clamping face define a rim. An insert is disposed within the spindle opening and comprises a first section, a central section and a second section. The sections define a U-shaped channel that extends along a part of the spindle opening and in which the rim is arranged.

### TECHNICAL FIELD

The present disclosure relates to accessories for power tools and power tools, such as oscillating power tools.

### BACKGROUND

Power tools, such as oscillating power tools are a favorite instrument of professional craftsmen, handymen, homeowners, and hobbyists. The typical oscillating tool is a handheld power tool configured for use with a variety of accessories that can be used for cutting, grinding, carving, sanding, polishing, scraping, and many other applications, referred to collectively as cutting operations. Specific examples of an oscillating tools are the DREMEL® Multi-Max Oscillating Multi-Tools sold by the Robert Bosch Tool Corporation.

When an accessory is attached to an oscillating power tool, a mounting portion of the accessory is clamped between a clamping flange and a spindle head of an accessory holder of the oscillating power tool. The mounting portion includes a first clamping face that abuts the clamping flange. A second clamping face that is spaced apart and opposite from the first clamping face abuts the spindle head. The mounting portion has a spindle opening defined by a first side surface that extends in an axial direction through the mounting portion from the first clamping face to the second clamping face. The spindle opening accommodates a spindle of the oscillating power tool. Pin openings defined by second side surfaces that extend in the axial direction through the mounting portion from the first clamping face to the second clamping face are arranged around the spindle opening and receive pins of the clamping flange which are arranged around the spindle. An area of the second clamping face adjacent around the spindle opening and an outer area of the spindle head, which is often round, have an overlap. Spindle heads of different oscillating power tools, e.g. when they are from different manufacturers, may have circumferences that are smaller or larger. For oscillating power tools with smaller spindle heads, hence whose circumference is smaller, the overlap with this area around the spindle opening may be rather small compared to a spindle head of a different oscillating power tool that is bigger in size, and in extreme cases it could happen that there is no overlap. It would be desirable to improve this in order to achieve a certain overlap. It may further also be desirable to have a versatile accessory that fits oscillating power tools with different spindle head sizes.

### SUMMARY

One aspect of this disclosure is directed to an accessory for an oscillating power tool having a spindle with a spindle head, and an accessory holder which includes the spindle head and a clamping flange to clamp the accessory between them, and which further includes pins arranged around the spindle, the accessory comprising: a working portion configured to perform an operation on a workpiece; and a mounting portion connected to the working portion, the mounting portion including: a first clamping face being configured to abut the clamping flange, and a second clamping face that is spaced apart and opposite from the first clamping face, the second clamping face being configured to abut the spindle head, a spindle opening defined by a first side surface that extends in an axial direction through the mounting portion from the first clamping face to the second clamping face and configured to accommodate the spindle, and pin openings defined by second side surfaces that extend in the axial direction through the mounting portion from the first clamping face to the second clamping face, arranged around the spindle opening, and configured to receive the pins of the clamping flange, the first clamping face, the spindle opening and the second clamping face defining a rim, wherein an insert is configured to be at least partially disposed within a portion of the spindle opening, the insert comprising: a central section that extends at least along and covers part of the first side surface of the spindle opening, a first section that radially extends away from the central section and that covers part of the first clamping face adjacent to the spindle opening, a second section that extends radially away from the first section and that covers part of the second clamping face adjacent to the spindle opening, and the first section, the second section and the central section of the insert along a length of the insert, when viewed in a cross section that is perpendicular to the second clamping face, define a U-shaped channel that extends along at least part of the spindle opening and in which, when the insert is attached to the accessory, at least part of the rim is arranged.

In another aspect, the first clamping face has a first portion that extends along the spindle opening and that is recessed along the axial direction, and wherein the first section of the insert is arranged along the first portion of the first clamping face.

In another aspect, the second clamping face has a second portion that extends along the spindle opening and that is recessed along the axial direction, and wherein the second section of the insert is arranged along the second portion of the second clamping face.

In another aspect, there is a gap between the central section and the first side surface. In another aspect, the U-shaped channel and the rim define a clearance fit.

In another aspect, the spindle opening defines a U-shape with a semicircular bottom area configured to accommodate the spindle and a second area which is open to a side of the mounting portion allowing the accessory to be mounted onto and removed from the spindle of an oscillating power tool.

In another aspect, the insert, along its length, has a semicircular segment that is arranged along the semicircular bottom area of the spindle opening.

In another aspect, the insert comprises a first straight segment and a second straight segment between which the semicircular segment is arranged, wherein the first straight segment, the second straight segment and the semicircular segment define a U-shape.

In another aspect, the insert is mounted into the spindle opening from a direction perpendicular to the axial direction.

In another aspect, the insert has a thickness extending in the axial direction, the thickness, along the axial direction, being equal or smaller than a distance between the first clamping face and the second clamping face.

In another aspect, the insert is removably attached to the spindle opening.

Another aspect is directed to a combination of an oscillating power tool and an accessory, the oscillating power tool comprising a spindle with a spindle head, and an accessory holder which includes the spindle head and a clamping flange between which the accessory is clamped, and which further includes pins arranged around the spindle; and the accessory comprising: a working portion configured to perform an operation on a workpiece, and a mounting portion connected to the working portion, the mounting portion being clamped between the clamping flange and the spindle head, the mounting portion comprising: a first clamping face that abuts the clamping flange, and a second clamping face that is spaced apart and opposite from the first clamping face, the second clamping face abuts the spindle head, a spindle opening defined by a first side surface that extends in an axial direction through the mounting portion from the first clamping face to the second clamping face, the spindle opening accommodating the spindle, and pin openings defined by second side surfaces that extend in the axial direction through the mounting portion from the first clamping face to the second clamping face, the pin openings being arranged around the spindle opening and receiving the pins, the first clamping face, the spindle opening and the second clamping face defining a rim, wherein an insert is at least partially disposed within a portion of the spindle opening, the insert comprising: a central section that extends at least along and covers part of the first side surface of the spindle opening, a first section that radially extends away from the central section and that covers part of the first clamping face adjacent to the spindle opening, a second section that extends radially away from the first section and that covers part of the second clamping face adjacent to the spindle opening, and the first section, the second section and the central section of the insert along a length of the insert, when viewed in a cross section that is perpendicular to the second clamping face, define a U-shaped channel that extends along at least part of the spindle opening and in which at least part of the rim is arranged.

The above aspects and other aspects will be explained in greater detail below with reference to the attached drawings.

### BRIEF DESCRIPTION OF THE DRAWINGS

FIG. 1 is a partial cross section of a sideview of an oscillating power tool and an accessory in an unclamped state;

FIG. 2 is a partial cross section of a sideview of the oscillating power tool and accessory as in FIG. 1 with the addition of an insert;

FIG. 3 is a perspective view of the accessory without a working portion and the insert;

FIG. 4 is another sideview of the accessory without a working portion and with the insert removed;

FIG. 5 is a top view of FIG. 4; and

FIG. 6 shows a cross section along the lines VI-VI in FIG. 3 enlarged and only in part.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

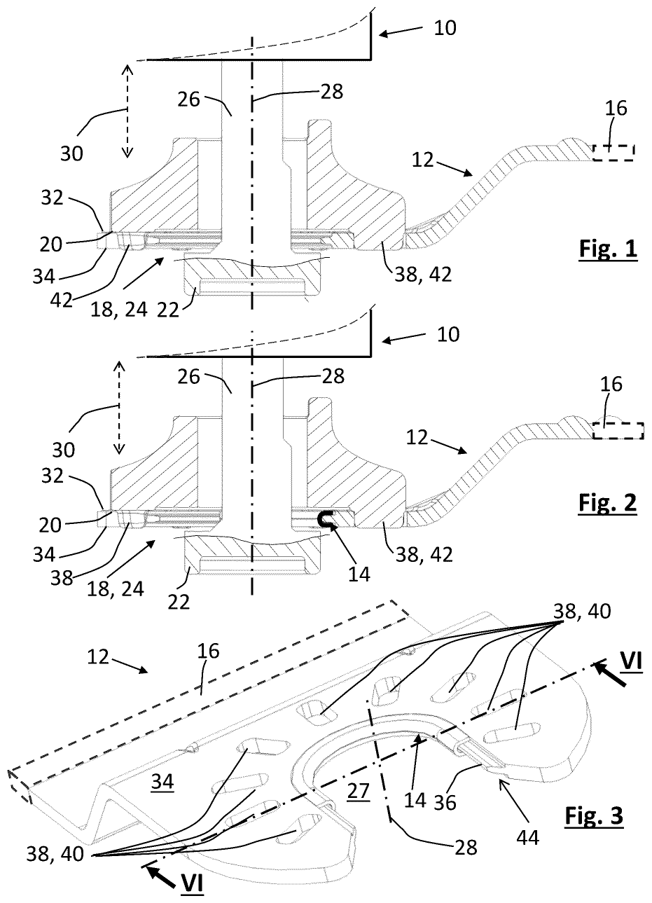

FIG. 1 shows a combination of an oscillating power tool 10 and an accessory 12 arranged at the oscillating power tool 10. FIG. 2 shows a combination of an oscillating power tool 10 as well as of an accessory 12 and an insert 14 attached to the oscillating power tool 10. The oscillating power tool 10 is only shown in part. Instead of the depicted oscillating power tool 10 the disclosure may also apply to other power tools such as rotary tools, saws, rotating brushes, etc. and combinations thereof with accessories 12.

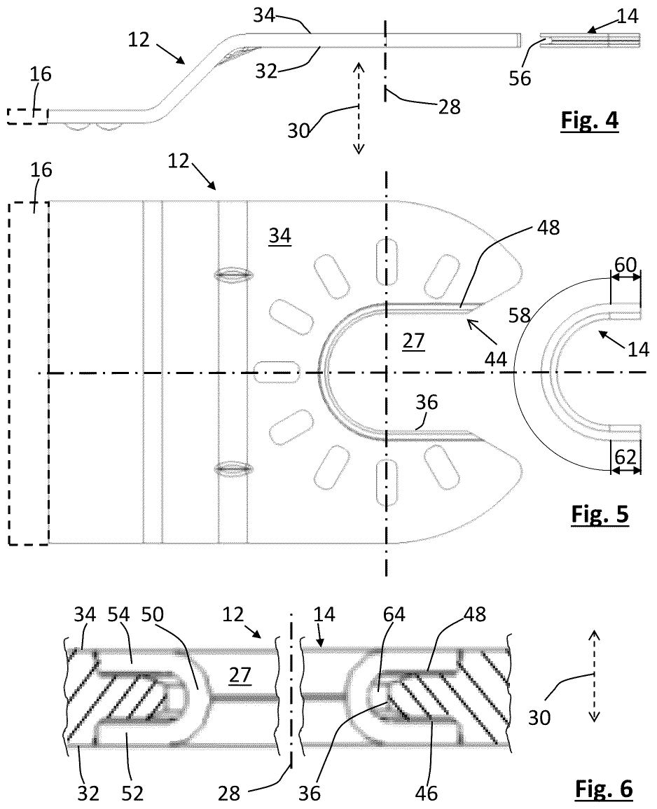

In addition to FIG. 2, FIGS. 3, 4, 5, and 6 show different views and aspects of the accessory 12 and the insert 14 without the oscillating power tool 10. The accessory 12 comprises a working portion 16 configured to perform an operation on a workpiece and a mounting portion 18 connected to the working portion 16. The working portion 16 is only hinted at with dotted lines. The working portion 16 may be a saw blade, a sanding disk, a brush, a hook etc. The working portion 16 may be used for cutting, grinding, grout removal, grinding, sanding, scraping, etc.

The mounting portion 18 is configured to be clamped between a clamping flange 20 and a spindle head 22 of an accessory holder 24 of the oscillating power tool 10. In FIGS. 1 and 2 the tool holder 24 is shown in an open position wherein the spindle head 22 is in a position further away from the clamping flange 20 allowing to mount or remove the accessory 12. The spindle head 22 is arranged on a spindle 26 of the oscillating power tool 10. The spindle 26 has an oscillating axis 28 which also defines an axial direction 30. The accessory 12 oscillates around the spindle 26. The angle of the oscillation or side-to-side oscillating motion of the spindle 26 is usually around 3-4 degrees. This angle allows for precise and controlled cutting, sanding, and scraping, making oscillating power tools versatile and effective for various applications.

The mounting portion 18 includes a first clamping face 32 that is configured to abut the clamping flange 20 (as shown in FIGS. 1 and 2), and a second clamping face 34 that is spaced apart and opposite from the first clamping face 32. The distance between the clamping face 32 and the clamping flange 20 along the axial direction 30 or thickness of the mounting portion 18 may be between 0.5 mm and 2 mm and is often about 0.6858 mm. The second clamping face 34 is configured to abut the spindle head 22. The mounting portion 18 has a spindle opening 27 defined by a first side surface 36 that extends in the axial direction 30 through the mounting portion 18 from the first clamping face 32 to the second clamping face 34. The spindle opening 27 is configured to accommodate, and in FIGS. 1 and 2 does accommodate, the spindle 26 of the oscillating power tool 10. The spindle opening 27 defines a U-shape with a semicircular bottom area configured to accommodate the spindle 26. The spindle opening 27 may have a second area which is open to a side of the mounting portion 18 allowing the accessory 12 to be mounted onto and removed from the spindle 26 of an oscillating power tool 10. This may be done by moving the accessory in a direction that is generally perpendicular to the axial direction 30. Pin openings 38 in the mounting portion 16 are defined by second side surfaces 40 that extend in the axial direction 30 through the mounting portion 18 from the first clamping face 32 to the second clamping face 34. The pin openings 38 are arranged around the spindle opening 27 and configured to receive pins 42 arranged the clamping flange 20. The pins 42 are arranged around the spindle 26 and protrude from the clamping flange 20. The pins 42 may also be arranged on the spindle head 22 and protrude from there. The size of the pin openings 38 and pins 42 is such that the pins 42 fit into the pin openings 38 without too much clearance; they may be of various shapes and sizes. The pin openings 38 may be round, square and/or elongated. They may be closed as shown or open towards the spindle opening 27 or the outside of the mounting portion. In the example shown there are nine pin openings 38. Neighboring pin openings 38 define an angle of 30. The number of pins 42 may vary. Often there are twelve, but there could also be just 4 or a number between. Angles between neighboring pins 42 should be such that they fit into pin openings 38. The accessory may be attached at various angles with respect to the oscillating power tool 10.

The first clamping face 32, the spindle opening 27 and the second clamping face 34 define a rim 44. The first clamping face 32 may have a first portion 46 that extends along the spindle opening 27 and that is recessed along the axial direction 30. The second clamping face 34 may have a second portion 48 that extends along the spindle opening 27 and that is recessed along the axial direction 30. This makes the rim 44 thinner in the axial direction 30. The distance between the first clamping face 32 and the second clamping face 34 or thickness of the mounting portion 18 between the first recessed portion 46 and the second recessed portion 48 is between 0.3 mm and 1 mm. But it is also possible that the first clamping surface 32 and the second clamping surface are flat until they reach the first side surface 36. The first side surface 36 may have a chamfer with first portion 46 46 and a chamfer with the second portion 48 48. Chamfers would also be possible if the first clamping surface 32 and the second clamping surface are flat until they reach the first side surface 36.

The insert 14 is disposed within the spindle opening 27. The insert 14 should be at least partially disposed within a portion of the spindle opening 27. A cross section of the insert 14 consists of a central section 50 that extends at least along and covers part of the first side surface 36 of the spindle opening 27. It further consists of a first section 52 that radially extends away from the central section 50 and that covers part of the first clamping face 32 adjacent to the spindle opening 27. This may be an area extending between 0.5 mm and 4 mm radially away from the first side surface 36. In the example shown the first section 52 covers the recessed first portion 46. The insert further consists of a second section 54 that extends radially away from the central section 50 and that covers part of the second clamping face 34 adjacent to the spindle opening 27. This may be an area extending between 0.5 mm and 4 mm radially away from the first side surface 36. In the example shown the second section 54 covers the recessed second portion 48. The first section 52, the second section 54 and the central section 50 of the insert 14 define a U-shaped channel 56 (e.g. in FIG. 3) that extends along the length of the insert 14. The central section 50 may have an inner radius adjacent to the first side surface 36 between 0.1 mm and 2 mm. As can be seen in FIG. 3, the U-shaped channel 56 extends along the spindle opening 27 when the insert 14 is mounted to or inserted into spindle opening. The U-shaped channel 56 of the insert 14 may extend along the length of the insert 14 when viewed in a cross section that is perpendicular to the second clamping face 34 (FIG. 2). The rim 44 is arranged in the U-shaped channel 56, when the insert 14 is attached to the accessory 12. The insert 14 may extend along at least part of the spindle opening 27 but may also extend along the entire length of the spindle opening 27. As can best be seen in FIG. 6, there may be a gap 64 between the central section 50 and the first side surface 36. The insert 14 has a thickness extending in the axial direction 30. The thickness is equal to or smaller than a distance between the first clamping face 32 and the second clamping face 34.

The first section 52 of the insert 14 may be arranged along a part of the first portion 46 of the first clamping face 32 or its entire length. The second section 54 of the insert 14 may be arranged along a part of the second portion 48 of the second clamping face 34 or its entire length. The insert 14, along its length, may have a semicircular segment 58 that is arranged along a corresponding semicircular bottom area of the spindle opening 27 or its first side surface 36. Along its length, the insert 14 comprises a first straight segment 60 and a second straight segment 62 between which the semicircular segment 58 is arranged. The first straight segment 60, the second straight segment 62 and the semicircular segment 58 define a U-shape. The insert 14 effectively reduces the width or the circumference of the spindle opening 27. This allows an improved attachment of the accessory 14 to the tool holder 24 as it increases an overlap between the spindle head 22 and the second clamping face 34.

The U-shaped channel 56 and the rim 44 may define a clearance fit. This allows the insert 14 to be easily removably attached without tools. The U-shaped channel 56 and the rim 44 may also define an interference fit which would be less loose than a clearance fit. The U-shaped channel and the rim may also define a minimal press fit so that the insert 14 does not that easily come off. A bigger or stronger press fit may be chosen, e.g. if the insert 14 is to be mounted permanently.

The insert 14 may be stamped and rolled, injection molded, 3D printed etc. It may be made of metal or plastic or another suitable material.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected. The words used in the specification are words of description rather than limitation, and it is understood that various changes may be made without departing from the spirit and scope of the disclosure as claimed. The features of various implementing embodiments may be combined to form further embodiments of the disclosed concepts.

1. An accessory for an oscillating power tool having a spindle with a spindle head, and an accessory holder which includes the spindle head and a clamping flange to clamp the accessory between them, and which further includes pins arranged around the spindle, the accessory comprising: a working portion configured to perform an operation on a workpiece; and a mounting portion connected to the working portion, the mounting portion including:
a first clamping face being configured to abut the clamping flange, and
a second clamping face that is spaced apart and opposite from the first clamping face, the second clamping face being configured to abut the spindle head,
the spindle opening defined by a first side surface that extends in an axial direction through the mounting portion from the first clamping face to the second clamping face and configured to accommodate the spindle, and
pin openings defined by second side surfaces that extend in the axial direction through the mounting portion from the first clamping face to the second clamping face, arranged around the spindle opening, and configured to receive the pins of the clamping flange,
the first clamping face, the spindle opening and the second clamping face defining a rim,
wherein an insert is configured to be at least partially disposed within a portion of the spindle opening, the insert comprising:
a central section that extends at least along and covers part of the first side surface of the spindle opening,
a first section that radially extends away from the central section and that covers part of the first clamping face adjacent to the spindle opening,
a second section that extends radially away from the first section and that covers part of the second clamping face adjacent to the spindle opening, and
the first section, the second section and the central section of the insert along a length of the insert, when viewed in a cross section that is perpendicular to the second clamping face, define a U-shaped channel that extends along at least part of the spindle opening and in which, when the insert is attached to the accessory, at least part of the rim is arranged.

2. The accessory of claim 1, wherein the first clamping face has a first portion that extends along the spindle opening and that is recessed along the axial direction, and wherein the first section of the insert is arranged along the first portion of the first clamping face.

3. The accessory of claim 1, wherein the second clamping face has a second portion that extends along the spindle opening and that is recessed along the axial direction, and wherein the second section of the insert is arranged along the second portion of the second clamping face.

4. The accessory of claim 1, wherein there is a gap 64 between the central section 50 and the first side surface 36.

5. The accessory of claim 1, wherein the U-shaped channel and the rim define a clearance fit, an interference fit, or a press fit.

6. The accessory of claim 1, wherein the spindle opening defines a U-shape with a semicircular bottom area configured to accommodate the spindle and a second area which is open to a side of the mounting portion allowing the accessory to be mounted onto and removed from the spindle.

7. The accessory of claim 6, wherein the insert, along its length, has a semicircular segment that is arranged along the semicircular bottom area of the spindle opening.

8. The accessory of claim 7, wherein the insert comprises a first straight segment and a second straight segment between which the semicircular segment is arranged, and wherein the first straight segment, the second straight segment and the semicircular segment define a U-shape.

9. The accessory of claim 8, wherein the insert is mounted into the spindle opening from a direction generally perpendicular to the axial direction.

10. The accessory of claim 1, wherein the insert has a thickness extending in the axial direction, the thickness, along the axial direction, being equal to or smaller than a distance between the first clamping face and the second clamping face.

11. The accessory of claim 1, wherein the insert is removably attached to the spindle opening.

12. A combination of an oscillating power tool and an accessory,
the oscillating power tool comprising a spindle with a spindle head, and an accessory holder which includes the spindle head and a clamping flange between which the accessory is clamped, and which further includes pins arranged around the spindle; and
the accessory comprising:
a working portion configured to perform an operation on a workpiece, and
a mounting portion connected to the working portion, the mounting portion being clamped between the clamping flange and the spindle head, the mounting portion comprising:
a first clamping face that abuts the clamping flange, and
a second clamping face that is spaced apart and opposite from the first clamping face, the second clamping face abuts the spindle head,
the spindle opening defined by a first side surface that extends in an axial direction through the mounting portion from the first clamping face to the second clamping face, the spindle opening accommodating the spindle, and
pin openings defined by second side surfaces that extend in the axial direction through the mounting portion from the first clamping face to the second clamping face, the pin openings being arranged around the spindle opening and receiving the pins,
the first clamping face, the spindle opening and the second clamping face defining a rim,
wherein an insert is at least partially disposed within a portion of the spindle opening, the insert comprising:
a central section that extends at least along and covers part of the first side surface of the spindle opening,
a first section that radially extends away from the central section and that covers part of the first clamping face adjacent to the spindle opening,
a second section that extends radially away from the first section and that covers part of the second clamping face adjacent to the spindle opening, and
the first section, the second section and the central section of the insert along a length of the insert, when viewed in a cross section that is perpendicular to the second clamping face, define a U-shaped channel that extends along at least part of the spindle opening and in which at least part of the rim is arranged.

13. The combination of claim 12, wherein the first clamping face has a first portion that extends along the spindle opening and that is recessed along the axial direction, and wherein the first section of the insert is arranged along the first portion of the first clamping face.

14. The combination of claim 12, wherein the second clamping face has a second portion that extends along the spindle opening and that is recessed along the axial direction, and wherein the second section of the insert is arranged along the second portion of the second clamping face.

15. The combination of claim 12, wherein the U-shaped channel and the rim define a clearance fit.

16. The combination of claim 12, wherein the spindle opening defines a U-shape with a semicircular bottom area configured to accommodate the spindle and a second area which is open to a side of the mounting portion allowing the accessory to be mounted onto and removed from the spindle.

17. The combination of claim 16, wherein the insert, along its length, has a semicircular segment that is arranged along the semicircular bottom area of the spindle opening.

18. The combination of claim 17, wherein the insert comprises a first straight segment and a second straight segment between which the semicircular segment is arranged, wherein the first straight segment, the second straight segment and the semicircular segment define a U-shape.

19. The combination of claim 18, wherein the insert is mounted into the spindle opening from a direction perpendicular to the axial direction.

20. The combination of claim 11, wherein the insert has a thickness extending in the axial direction, the thickness, along the axial direction, being equal or smaller than a distance between the first clamping face and the second clamping face.
